(19) United States
(12) Patent Application Publication
(10) Pub. No.: US 2004/0186907 A1
(43) Pub. Date: Sep. 23, 2004

(54) Technique for optimizing backoff for a shared resource

(76) Inventor: Maarten Menzo Wentink, Utrecht (NL)

Correspondence Address: DEMONT & BREYER, LLC, SUITE 250, 100 COMMONS WAY, HOLMDEL, NJ, 07733, US

(21) Appl. No.: 10/689,018

(22) Filed: Oct. 20, 2003

Related U.S. Application Data
(60) Provisional application No. 60/455,322, filed on Mar. 17, 2003.

(51) Int. Cl. G06F 15/173

(52) U.S. Cl. 709/225

(57) ABSTRACT

A technique is disclosed that replaces the slot-based backoff in the prior art with an event-based backoff, in which the event-based backoff interval accounts for other stations contending for a shared resource. The access sequence in the illustrative embodiment of the present invention enables a station to know in advance the length of the wait for accessing the shared resource. As a result, during the backoff interval the station can power down its receiver and conserve power.

### CROSS-REFERENCE TO RELATED APPLICATIONS

This application claims the benefit of U.S. Provisional Patent Application Serial No. 60/455,322, entitled “Backoff Substitution on a Shared Communications Channel,” filed on Mar. 17, 2003 (Attorney Docket: 680-064us), which is incorporated by reference.

### FIELD OF THE INVENTION

The present invention relates to telecommunications in general, and, more particularly, to local area networks (LAN).

### BACKGROUND OF THE INVENTION

FIG. 1 depicts a schematic diagram of network 100 in the prior art. Network 100 operates in accordance with a set of protocols, and comprises shared resource 102 and telecommunication stations 101-1 through 101-K, wherein K is a positive integer. Network 100, for example, can be an Institute of Electrical and Electronics Engineers (IEEE) 802.11 wireless local area network with shared resource 102 acting as the shared-communications channel. Host computers typically use stations 101-1 through 101-K, in an arrangement of one station paired with each host computer, to enable communications between the host computers or between the host computers and other devices, such as printer servers, email servers, file servers, etc. Station 101-3 operates as an “access point” in that it enables other stations within network 100 to communicate with each other by distributing access parameters and other information pertinent to network 100 as needed.

Stations 101-1 through 101-K contend with each other to use shared resource 102 to communicate. As a result, stations 101-1 through 101-K must use access rules to resolve the contention that occurs. Each of stations 101-1 through 101-K listens for transmissions (i.e., performs carrier sensing) on shared resource 102. Only if station 101-1, as an example, does not detect a transmission for a fixed period of time known as the “interframe space” does station 101-1 attempt to contend for access to shared resource 102.

In contending for access, station 101-1 then performs a backoff. The backoff consists of waiting a random number of idle time slots, where each slot in this “slot-based backoff” is a fixed time interval. Station 101-1 chooses randomly the number of backoff slots that it must wait between zero and a contention window parameter value. Only after the backoff period can station 101-1 transmit a frame (i.e., a packet).

During the backoff period, station 101-1 must continuously monitor shared resource 102 to determine whether or not the channel is idle. This means that station 101-1 must keep its receiver powered on during this time.

Station 101-1's wait for access to shared resource 102 might be interrupted by frame transmissions by other stations. For example, station 101-2 might attempt to transmit before station 101-1 because station 101-2 generates a number of backoff slots that is less than the number generated by station 101-1 In this case, the backoff countdown process halts for station 101-1 and begins again only when shared resource 102 has been idle for another interframe space after the end of the interrupting transmission.

The advantage of slot-based backoff is that it resolves contention and minimizes the event of multiple stations attempting to transmit at the same time (i.e., a collision event) while maintaining a relatively high level of efficiency in using shared resource 102. Station 101-1's wait for access, however, can be substantial, especially if other, earlier-to-transmit stations have long transmission times. Consequently, the disadvantage of slot-based backoff is that keeping station 101-1's receiver turned on during the wait for access consumes power.

What is needed is a technique to access a shared resource that is governed by contention-based access without the receiver power consumption disadvantages in the prior art.

### SUMMARY OF THE INVENTION

The present invention is a technique that enables access to a shared resource that is governed by contention-based access while reducing receiver power consumption. The illustrative embodiment of the present invention replaces the slot-based backoff in the prior art with an event-based backoff, in which the event-based backoff interval accounts for other stations contending for the shared resource.

The illustrative embodiment of the present invention determines the backoff interval that a station should use by measuring the average wait time incurred during previous access attempts governed by slot-based backoff before that station finally gained access to the shared resource. The wait time comprises possibly many slot-based backoff intervals and transmission intervals caused by other stations gaining access to the shared resource first.

After the event-based backoff, in some embodiments, the station waits a short, slot-based backoff time to minimize the collisions that might occur when multiple event-based backoffs expire simultaneously.

The duration of the event-based backoff in the illustrative embodiment is known in advance. Therefore, during the backoff interval, the station powers down its receiver in some embodiments and conserves power.

An illustrative embodiment of the present invention comprises: using a shared resource; and refraining from contending for access to the shared resource for a backoff interval after the last use of the shared resource; wherein the backoff interval is based on at least one previous backoff interval that is associated with at least one previous use of the shared resource.

### BRIEF DESCRIPTION OF THE DRAWINGS

FIG. 1 depicts a schematic diagram of network 100 in the prior art.

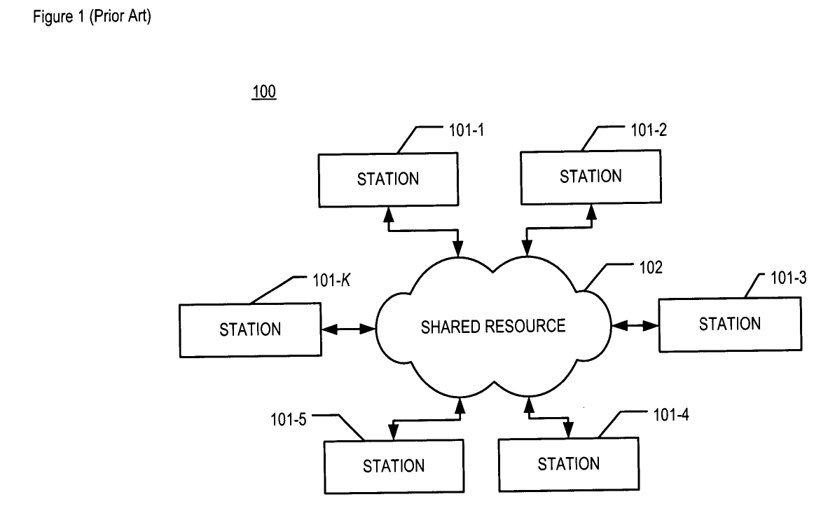

FIG. 2 depicts a schematic diagram of network 200 in accordance with the illustrative embodiment of the present invention.

FIG. 3 depicts a block diagram of the salient components of station 201-i in accordance with the illustrative embodiment of the present invention.

FIG. 4 depicts a flowchart of the illustrative embodiment of the present invention.

FIG. 5 depicts a timing diagram of the illustrative embodiment of the present invention.

FIG. 6 depicts a graphical diagram of the relationship between the utilization of shared resource 202 and the degree to which station 201-i uses event-based backoff, in accordance with the illustrative embodiment of the present invention.

### DETAILED DESCRIPTION

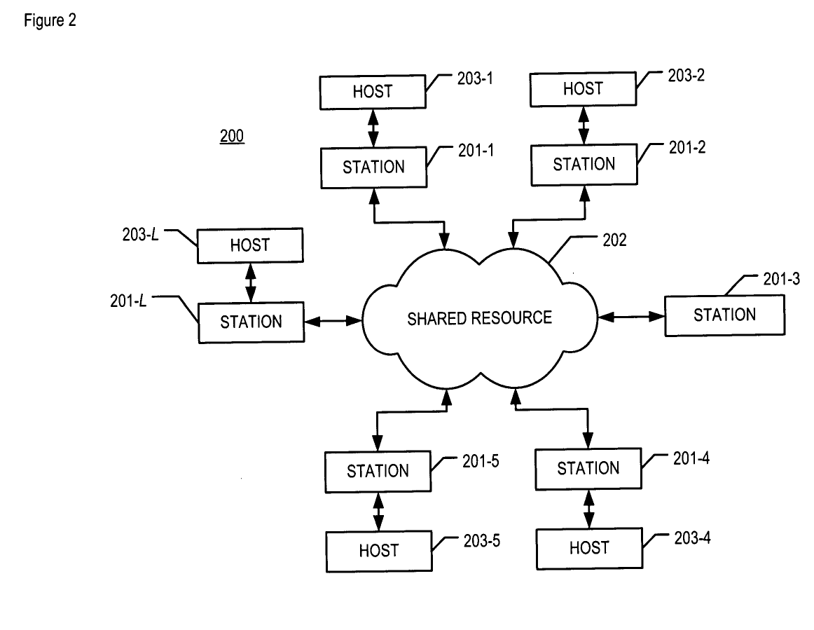

FIG. 2 depicts a schematic diagram of network 200 in accordance with the illustrative embodiment of the present invention. Network 200 operates in accordance with a set of protocols (e.g., IEEE 802.11, etc.) and comprises stations 201-1 through 201-L, wherein L is a positive integer, and shared resource 202, interconnected as shown. It will be clear to those skilled in the art how to make and use shared resource 202.

In some embodiments, station 201-3 operates as an “access point” in that over time it distributes access parameters and other information pertinent to network 200. It will be clear, however, to those skilled in the art, after reading this specification, how to make and use network 200 without an access point.

Station 201-i, for i=1 to L, is capable of receiving data messages from host computer 203-i and transmitting over shared resource 202 data frames comprising the data received from host computer 203-i. Station 201-i is also capable of receiving data frames from shared resource 202 and sending to host computer 203-i data messages comprising data from the data frames. It will be clear to those skilled in the art, after reading this specification, how to make and use station 201-i.

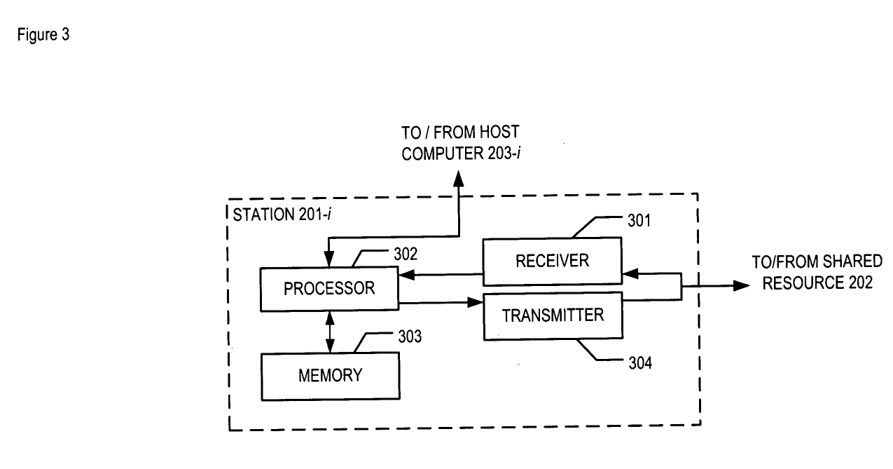

FIG. 3 depicts a block diagram of the salient components of station 201-i in accordance with the illustrative embodiment of the present invention. Station 201-i comprises receiver 301, processor 302, memory 303, and transmitter 304, interconnected as shown. In some embodiments where host computer 203-i is not associated with station 201-i (i.e., as with station 201-3), the path to host computer 203-i is not present.

Receiver 201 is a circuit that is capable of receiving frames from shared resource 202, in well-known fashion, and of forwarding them to processor 302. It will be clear to those skilled in the art how to make and use receiver 301.

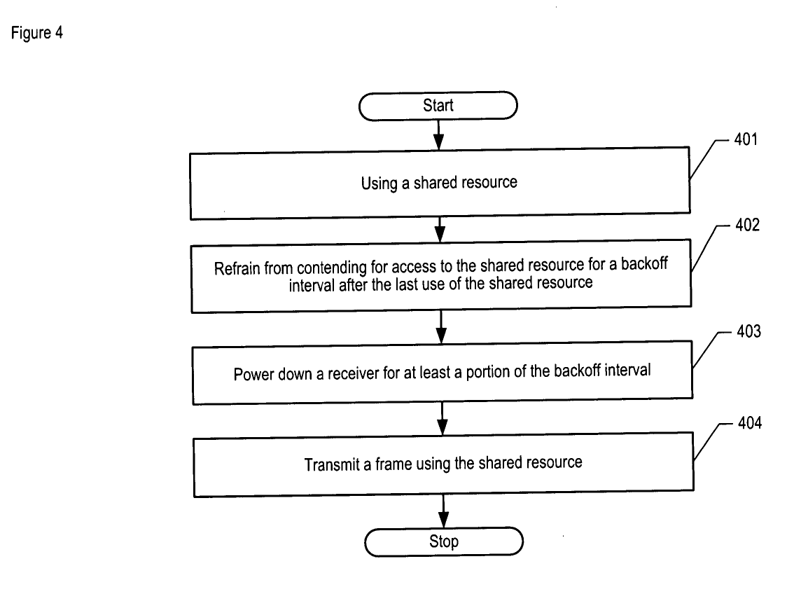

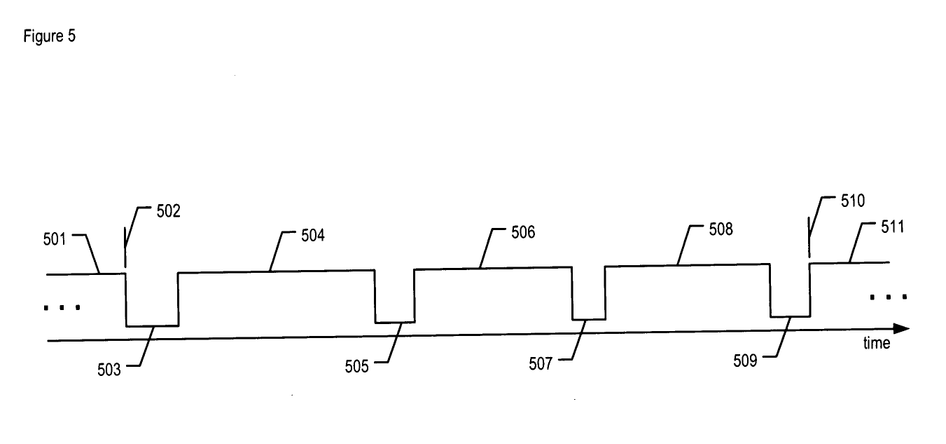

Processor 302 is a general-purpose processor that is capable of performing the tasks described below and with respect to FIGS. 4 and 5. It will be clear to those skilled in the art, after reading this specification, how to make and use processor 302.

Memory 303 is capable of storing programs and data used by processor 302. It will be clear to those skilled in the art how to make and use memory 303.

Transmitter 304 is a circuit that is capable of receiving frames from processor 302, in well-known fashion, and of transmitting them on shared resource 202. It will be clear to those skilled in the art how to make and use transmitter 304.

FIG. 4 depicts a flowchart of the salient tasks performed by the illustrative embodiment of the present invention. It will be clear to those skilled in the art which tasks depicted in FIG. 4 can be performed simultaneously or in a different order than that depicted.

At task 401, a station constituting network 200 uses shared resource 202 in well-known fashion. For example, an IEEE 802.11 station can use shared resource 202 as a shared-communications channel to transmit a frame of data.

At task 402, station 201-1, used here for illustrative purposes, needs to access shared resource 202 to transmit a frame, but refrains from contending for access to shared resource 202 for a backoff interval after the last use of shared resource 202. The backoff interval is based on one or more previous backoff intervals associated with one or more previous uses of shared resource 202. Each previous backoff interval can comprise one or more slot-based backoffs, or it can comprise one or more previously-occurring backoffs of the illustrative embodiment (i.e., event-based backoff), or it can comprise both.

Station 201-1 determines the backoff interval ahead of time, in some embodiments, so that station 201-1 is ready to use the backoff interval when needed.

As part of determining the backoff interval, station 201-1 measures the average wait time that station 201-1 had incurred during one or more previous access attempts before station 201-1 eventually gained access to shared resource 202. As part of the measuring task, station 201-1 observes the periods of backoff that it had experienced during and associated with N frames actually transmitted.

During this N-frame training period, in some embodiments, station 201-1 tracks the total number of backoff slots it has generated, s, and the total duration of backoff, d, to determine a value for the ratio d/s. For example, FIG. 5 depicts a timing diagram in the scenario wherein N is equal to one, in accordance with the illustrative embodiment of the present invention. Shared resource 202 is in use at the time of transmission 501 when station 201-1 determines that it has to transmit a frame. The parameter d is a measure of the total time interval between i) when station 201-1 first sensed shared resource 202 become idle, at time 502, and ii) when station 201-1 eventually transmits its frame (transmission 511) beginning at time 510. In between time 502 and time 510 are alternating periods of idle (i.e., contention intervals 503, 505, 507, and 509) and busy (i.e., transmissions 504, 506, and 508). Transmissions 504, 506, and 508 correspond to when other stations beat out station 201-1 in gaining access to shared resource 202. The parameter d comprises the waits experienced during i) the interframe spaces and backoff slot periods constituting contention intervals 503, 505, 507, and 509, and ii) the transmission times contributed by earlier-to-transmit stations, represented by transmissions 504, 506, and 508. The parameter s is equal to the total number of slots generated by station 201-1 across contention intervals 503, 505, 507, and 509.

The value of the ratio d/s becomes the effective length of each time slot as experienced by station 201-1 (as opposed to the defined length of each time slot). Using the ratio d/s enables compatibility with existing backoff-related parameters, as will be explained later. If station 201-1 is one of few stations (or the only station) on the network and the frame transmission time is short, then the ratio d/s approaches the defined length of each time slot (i.e., is small). If, however, there are many stations on the network or each station's frame transmission time is long or both, then the ratio d/s is large.

The value for N in the N-frame training period in some embodiments can be set to a large number to improve the accuracy in assessing an overall ratio d/s. Alternatively, N can be set to one (or some small number) and station 201-1 can update the ratio d/s as a moving average. It will be clear to those skilled in the art, after reading this specification, how to set a value for N and how to update d/s.

Once station 201-1 determines the ratio d/s, it calculates the backoff interval as being equal to:

(d/s)*(BW/2) (Eq. 1)

wherein BW is the backoff window in slots. BW can be set, for example, to the IEEE 802.11 parameter for minimum contention window (CWₘᵢₙ). It will be clear to those skilled in the art, after reading this specification, how to tailor the backoff interval using BW. It will also be clear to those skilled in the art, after reading this specification, how to use the waiting time observed to determine backoff interval in a different way than by using Equation 1. For example, the average waiting time per frame to be transmitted can be used as is or with a percentage scaling factor applied.

It will be clear to those skilled in the art, after reading this specification, how to make and use other techniques to determine a backoff interval that is based on one or more previous backoff intervals.

At task 403 in some embodiments, station 201-1 powers down receiver 301 in well-known fashion during at least a portion of the backoff interval. Powering down receiver 301 reduces power consumption, extending battery life where used.

At task 404 in some embodiments, station 201-1 transmits a frame using shared resource 202 in well-known fashion after refraining for the backoff interval.

Station 201-1 can repeat the N-frame training period going forward or not. If station 201-1 repeats the N-frame training period going forward, station 201-1 can determine the average waiting time based on either slot-based backoff or the event-based backoff of the illustrative embodiment. Some or all of stations 201-1 through 201-L can alternate between using slot-based backoff and the event-based backoff of the illustrative embodiment, or continue to use slot-based backoff only, or continue to use solely the event-based backoff of the illustrative embodiment.

The backoff interval determined, in some embodiments, applies for the next M frames to be transmitted by one or more stations constituting network 200. The relative values of N and M influence the efficiency of the determined backoff interval of the illustrative embodiment versus the reaction time to the changing conditions of shared resource 202. It will be clear to those skilled in the art, after reading this specification, how to set a value for M, both independent of and with respect to N.

After the event-based backoff, as part of the backoff interval in some embodiments, station 201-1 waits a slot-based backoff period. The slot-based backoff period can be introduced to minimize the collisions that might occur when multiple event-based backoffs expire simultaneously. The slot-based backoff process comprises determining a random wait interval in well-known fashion. The slot-based backoff period can be set relatively short, in the sense that the contention window used is small, relative to the overall backoff interval. In some embodiments, the slot-based backoff period can be a nonzero value only after a collision has already occurred that results in an unsuccessful transmission attempt. This condition can be met in IEEE 802.11, for example, by setting CWmin to zero and CWmax to a nonzero value.

In some embodiments, the backoff interval is constrained to be at least equal to interframe periods known in the art (e.g., IEEE 802.11 distributed coordination function interframe space [DIFS], etc.). This constraint can be introduced for reasons of compatibility with other stations that do not use the backoff of the illustrative embodiment.

The technique used to determine the backoff interval can be located at each station 201-i (e.g., station 201-1 as in the example provided, etc.), or it can be centralized (e.g., at an access point such as station 201-3, etc.). If the technique is located at a centralized point, such as an access point, the centralized point updates and distributes a value representing the backoff interval on an ongoing basis, as well as other relevant information, through management frames such as beacon frames. It will be clear to those skilled in the art how to distribute information through management frames. Station 201-i receives the value and uses it to determine the backoff interval.

In some embodiments, station 201-1 uses the backoff interval determined in the illustrative embodiment only when in a power save mode that other transmitting stations (e.g., station 201-3 serving as an access point, etc.) are aware of. When in a power save mode, station 201-1 may power down its receiver, its transmitter, or both. When other stations are aware of station 201-1 being in power save mode, the other stations do not transmit frames to station 201-1 and, as a result, station 201-1 does not receive frames during the time that it has powered down receiver 301. When not in a power save mode, in some embodiments, station 201-1 uses slot-based backoff in well-known fashion rather than the event-based backoff of the illustrative embodiment.

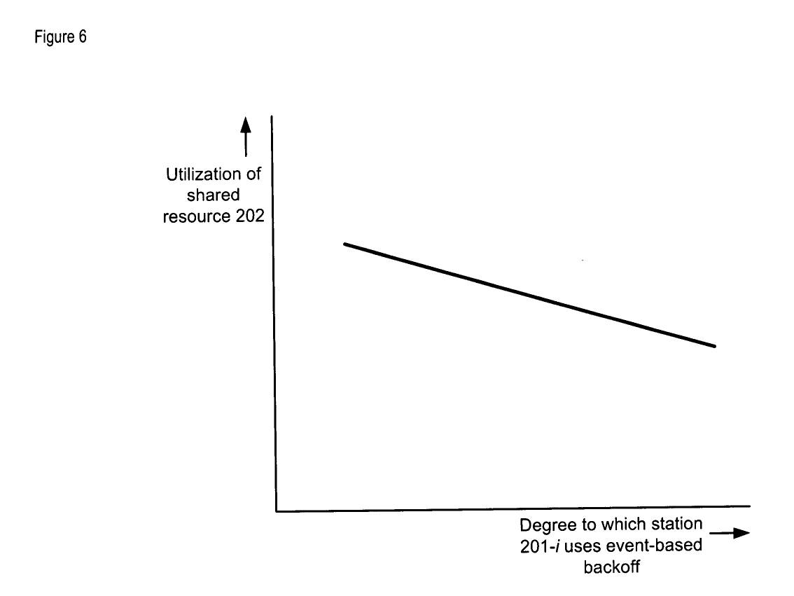

FIG. 6 depicts the relationship between shared resource utilization and the degree to which event-based backoff is used, in accordance with the illustrative embodiment of the present invention. Shared resource utilization refers to the percentage of time that shared resource 202 is busy (i.e., utilized). When shared resource 202 is not busy (i.e., is idle), it can be because of several reasons. One reason is that when shared resource 202 becomes idle, it stays idle for at least the interframe space period plus the backoff interval (i.e., slot-based or event-based) in effect.

Furthermore, since each event-based backoff interval is typically longer than each of the individual slot-based backoff intervals, there is more of a likelihood that shared resource 202 becomes available, but no station is able to transmit shortly thereafter. The more event-based backoff is used over slot-based backoff or 2) the longer the backoff interval, the less shared resource 202 is utilized. The reverse is also true in that 1) the less event-based backoff is used or 2) the shorter the backoff interval, the more shared resource 202 is utilized. This relationship is why, in some embodiments, a scaling factor is used to adjust the event-based backoff interval. The scaling factor can be used to tune the utilization of shared resource 202 by adjusting the degree to which the illustrative embodiment is used, even if the receiver power consumption changes as well. It will be clear to those skilled in the art, after reading this specification, how to tune the degree to which event-based backoff is used.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
using a shared resource; and
refraining from contending for access to said shared resource for a backoff interval after the last use of said shared resource;
wherein said backoff interval is based on at least one previous backoff interval that is associated with at least one previous use of said shared resource.

2. The method of claim 1 further comprising transmitting a frame using said shared resource after said refraining, wherein said shared resource is a shared-communications channel.

3. The method of claim 1 further comprising powering down a receiver for at least a portion of said backoff interval.

4. The method of claim 1 wherein said backoff interval is further based on at least one of:
i) a moving average; and
ii) a contention window value.

5. The method of claim 1 wherein said backoff interval comprises a time interval that is based on a random number.

6. The method of claim 5 wherein said time interval can assume a nonzero value only after an unsuccessful attempt to transmit occurs.

7. The method of claim 1 wherein said backoff interval is constrained to be at least as long as an IEEE 802.11 distributed interframe space.

8. A method comprising:
using a shared resource; and
refraining from contending for access to said shared resource for a backoff interval after the last use of said shared resource;
powering down a receiver for at least a portion of said backoff interval;
wherein said backoff interval is based on at least one previous backoff interval that is associated with at least one previous use of said shared resource.

9. The method of claim 8 further comprising transmitting a frame using said shared resource after said refraining, wherein said shared resource is a shared-communications channel.

10. The method of claim 8 wherein said backoff interval is further based on at least one of:
i) a moving average; and
ii) a contention window value.

11. The method of claim 8 wherein said backoff interval comprises a time interval that is based on a random number.

12. The method of claim 11 wherein said time interval can assume a nonzero value only after an unsuccessful attempt to transmit occurs.

13. An apparatus comprising:
a transmitter for using a shared resource; and
a processor for refraining from contending for access to said shared resource for a backoff interval after the last use of said shared resource;
wherein said backoff interval is based on at least one previous backoff interval that is associated with at least one previous use of said shared resource.

14. The apparatus of claim 13 further comprising a receiver for powering down for at least a portion of said backoff interval.

15. The apparatus of claim 14 wherein said receiver is also for receiving a value representing said backoff interval.

16. The apparatus of claim 13 wherein said processor is also for determining said backoff interval.

17. The apparatus of claim 13 wherein said shared resource is a shared-communications channel and wherein said transmitter communicates over said shared-communications channel in accordance with an IEEE 802.11 protocol.

18. An apparatus comprising:
a host computer for directing a station to use a shared resource; and
said station for:
(1) using said shared resource;
(2) refraining from contending for access to said shared resource for a backoff interval after the last use of said shared resource; and
(3) powering down a receiver for at least a portion of said backoff interval;
wherein said backoff interval is based on at least one previous backoff interval that is associated with at least one previous use of said shared resource.

19. The apparatus of claim 18 further comprising an access point for:
(1) determining said backoff interval; and
(2) distributing a value representing said backoff interval.

20. The apparatus of claim 19 wherein said station is also for receiving said value representing said backoff interval.

21. The apparatus of claim 18 wherein said backoff interval comprises a time interval that is based on a random number.
